(19) United States
(12) Patent Application Publication
(10) Pub. No.: US 2026/0140800 A1
(43) Pub. Date: May 21, 2026

(54) COMPUTER SYSTEMS AND METHODS FOR HANDLING MULTI-PROCESSES AND MULTI-THREADS

(71) Applicant: Novatek Microelectronics Corp., Hsinchu (TW)

(72) Inventors: Hsu-Che Chiang, Taichung City (TW); Chi-Ming Yuan, Taipei City (TW); Kuei-Pin Tsai, Hsinchu City (TW); Chia-Lin Chang, Hsinchu County (TW)

(73) Assignee: Novatek Microelectronics Corp., Hsinchu (TW)

(21) Appl. No.: 18/955,816

(22) Filed: Nov. 21, 2024

(51) Int. Cl. G06F 9/54

(52) U.S. Cl. CPC G06F 9/547

(57) ABSTRACT

Methods and computer systems for handling multi-processes and multi-threads are proposed. The method for handling multi-processes is applicable to a computer system to control a graphic processor to handle tasks of a process sent from a client terminal by a child process technique or based on a process ID. The method for handling multi-threads is applicable to a computer system to control a graphic processor to handle tasks of a thread sent from a client terminal based on a thread ID.

### TECHNICAL FIELD

The disclosure relates to a technique for handling multi-processes and multi-threads.

### BACKGROUND

The graphic processing units (GPU) has provided a powerful platform to accelerate graphic and compute-intensive applications. Due to the constraint of hardware cost and power consumption, a single GPU is commonly shared by multiple applications in a GPU-based embedded system such as an autonomous vehicle system to concurrently process multiple independent streams of data. However, the benchmark of graphic application interfaces (APIs) such as OpenGL for rendering 2D and 3D vector graphics only support single-thread and single-process implementations for more than one operating systems on a virtual machine. OpenGL context is a state machine that holds state variables and manages OpenGL functions. The current OpenGL context is thread-local information, and if OpenGL commands from different threads are not properly managed and isolated, unexpected rendering results may occur due to misunderstandings or misinterpretations. Moreover, awareness of such issue should also be considered for OpenGL commands from different processes to remain completely independent with no interference from each other.

### SUMMARY OF THE DISCLOSURE

Methods and computer systems for handling multi-processes and multi-threads are proposed.

According to one of the exemplary embodiments, the computer system for handling multi-processes includes a graphic processor and a processor. The processor is configured to create a server socket to listen for incoming connection request, fork a first child process to handle tasks of a first process received from a client terminal in response to a connection request associated with the first process sent from the client terminal being accepted by the server socket, and control the graphic processor to perform a first graphic task of the first process by the first child process in response to the first graphic task of the first process being received from the client terminal by the first child process.

According to one of the exemplary embodiments, the computer system for handling multi-processes includes a processor. The processor is configured to create a server socket to listen for incoming connection request, fork a first child process to handle tasks of a first process received from a client terminal in response to a connection request associated with the first process sent from the client terminal being accepted by the server socket, and control an external graphic processor to perform a first graphic task of the first process by the first child process in response to the first graphic task of the first process being received from the client terminal by the first child process.

According to one of the exemplary embodiments, the method for handling multi-processes is applicable to a computer system having a processor and a graphic processor and is performed by the processor. The method includes creating a server socket to listen for incoming connection request, forking a first child process to handle tasks of a first process received from a client terminal in response to a connection request associated with the first process sent from the client terminal being accepted by the server socket, and controlling the graphic processor to perform a first graphic task of the first process by the first child process in response to the first graphic task of the first process being received from the client terminal by the first child process.

According to one of the exemplary embodiments, the method for handling multi-processes is applicable to a computer system having a processor and is performed by the processor. The method includes creating a server socket to listen for incoming connection request, forking a first child process to handle tasks of a first process received from a client terminal in response to a connection request associated with the first process sent from the client terminal being accepted by the server socket, and controlling an external graphic processor to perform a first graphic task of the first process by the first child process in response to the first graphic task of the first process being received from the client terminal by the first child process.

According to one of the exemplary embodiments, the computer system for handling multi-threads includes a graphic processor and a processor. The processor is configured to receive a first message sent from a client terminal by a first child process forked from a parent process of the computer system, determine whether a first thread identification (ID) included in the first message is known, and control the graphic processor to perform a first graphic task assigned in the first message by the first child process according to the first thread ID in response to the first thread ID being known.

According to one of the exemplary embodiments, the computer system for handling multi-threads includes a processor. The processor is configured to receive a first message sent from a client terminal by a first child process forked from a parent process of the computer system, determine whether a first ID included in the first message is known, and control an external graphic processor to perform a first graphic task assigned in the first message by the first child process according to the first thread ID in response to the first thread ID being known.

According to one of the exemplary embodiments, the method for handling multi-threads is applicable to a computer system having a processor and a graphic processor and is performed by the processor. The method includes receiving a first message sent from a client terminal by a first child process forked from a parent process of the computer system, determining whether a first thread ID included in the first message is known, and controlling the graphic processor to perform a first graphic task assigned in the first message by the first child process according to the first thread ID in response to the first thread ID being known.

According to one of the exemplary embodiments, the method for handling multi-threads is applicable to a computer system having a processor and is performed by the processor. The method includes receiving a first message sent from a client terminal by a first child process forked from a parent process of the computer system, determining whether a first thread ID included in the first message is known, and controlling an external graphic processor to perform a first graphic task assigned in the first message by the first child process according to the first thread ID in response to the first thread ID being known.

According to one of the exemplary embodiments, the computer system for handling multi-processes includes a graphic processor and a processor. The processor is configured to receive a first message sent from a client terminal, determine whether a first process ID included in the first message is known, and control the graphic processor to perform a first graphic task of a first process assigned in the first message by the parent process according to the first process ID in response to the first process ID being known.

According to one of the exemplary embodiments, the computer system for handling multi-processes includes a processor. The processor is configured to receive a first message sent from a client terminal, determine whether a first process ID included in the first message is known, and control an external graphic processor to perform a first graphic task of a first process assigned in the first message according to the first process ID in response to the first process ID being known.

According to one of the exemplary embodiments, the method for handling multi-processes is applicable to a computer system having a processor and a graphic processor and is performed by the processor. The method includes receiving a first message sent from a client terminal, determining whether a first process ID included in the first message is known, and controlling the graphic processor to perform a first graphic task of a first process assigned in the first message according to the first process ID in response to the first process ID being known.

According to one of the exemplary embodiments, the method for handling multi-processes is applicable to a computer system having a processor and is performed by the processor. The method includes receiving a first message sent from a client terminal, determining whether a first process ID included in the first message is known, and controlling an external graphic processor to perform a first graphic task of a first process assigned in the first message according to the first process ID in response to the first process ID being known.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of a computer system in accordance with an exemplary embodiment of the disclosure.

FIG. 2 illustrates a flowchart of a method for handling multi-processes in accordance with an exemplary embodiment of the disclosure.

FIG. 3 illustrates a flowchart of a method for handling multi-threads in accordance with an exemplary embodiment of the disclosure.

FIG. 4 illustrates a flowchart of a method for handling multi-processes in accordance with another exemplary embodiment of the disclosure.

FIG. 5 illustrates a schematic diagram of a computer system in accordance with another exemplary embodiment of the disclosure.

To make the above features and advantages of the application more comprehensible, several embodiments accompanied with drawings are described in detail as follows.

### DESCRIPTION OF THE EMBODIMENTS

To solve the prominent issue, some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

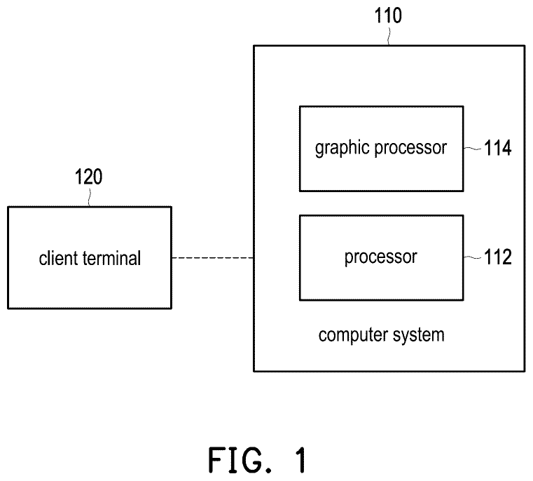

FIG. 1 illustrates a schematic diagram of a computer system in accordance with an exemplary embodiment of the disclosure. All components and configurations of the computer system are first introduced in FIG. 1. The functionalities of the components are explained in more details later on.

Referring to FIG. 1, a computer system 110 would include a processor 112 and a graphic processor 114. The computer system 110 may be a computer or an electronic device designed for rendering images, videos, and graphic-intensive tasks based on commands sent from a client terminal 120. The processor 112 may be one or more of a central processing unit (CPU), an application processor (AP), a programmable general purpose or special purpose microprocessor, a digital signal processor (DSP), a field programmable array (FPGA), an application specific integrated circuit (ASIC), other similar devices, integrated circuits, or a combination thereof. The graphic processor 114 may be a graphical processing unit (GPU) with massive graphics processing capabilities, other similar devices, integrated circuits, or a combination thereof. The processor 112 and the graphic processor 114 may also be formed as integrated circuits such as a system-on-chip (SoC), where the processor 112 may interact with the graphic processor 114 through a graphic API, and yet the disclosure is not limited in this regard.

The client terminal 120 may be a computer or an electronic device that utilizes the GPU resource from the computer system 110, and therefore the computer system 110 may also be considered as a server or a host that provides graphic resources to the client terminal 120. In one scenario, the computer system 110 and the client terminal 120 may respectively be a center console and an interactive screen display in an autonomous vehicle system. In another scenario, the computer system 110 and the client terminal 120 may respectively be a TV console and a smart phone in a smart living environment. The computer system 110 would include a dynamic-link library (referred to as “server library” hereafter) that implement graphic APIs such as OpenGL. The dynamic-link library may be considered as a user-space device driver that is responsible for controlling the graphic processor 114. The client terminal 120 would also include a dynamic-link library (referred to as “client library”) corresponding to the server library, and yet the client library is not capable of directly controlling the graphic processor 114.

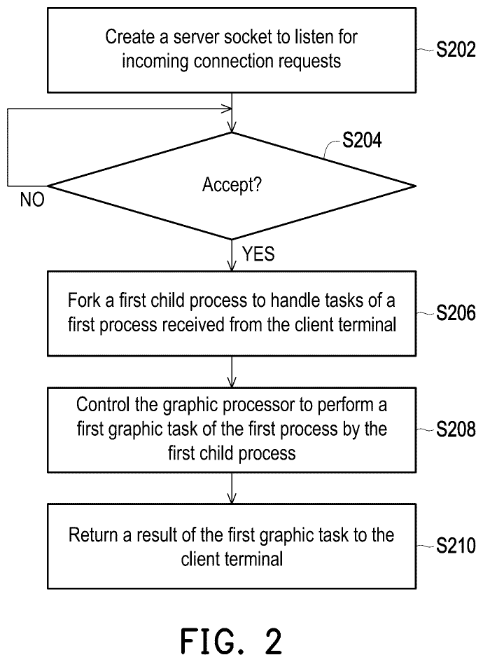

FIG. 2 illustrates a flowchart of a method for handling multi-processes in accordance with an exemplary embodiment of the disclosure, where the steps of FIG. 2 may be implemented by the computer system 110 as illustrated in FIG. 1.

It should be first noted that, prior to the proposed multi-processes scheme, it is assumed that an initialization procedure for the client terminal 120 has already been taken place upon an activation of an application made up of one process. The client library with a modified initialization function would be loaded for the application on the client terminal 120, where such modified initialization function would create a client socket for the application on the client terminal 120 to establish a connection with the computer system 110. Moreover, it is also assumed that the server library has already been loaded in the computer system 110 upon being started up.

Now, referring FIG. 2 in conjunction with FIG. 1, the processor 112 of the computer system 110 would create a server socket to listen for incoming connection requests (Step S202) and determine whether to accept or reject each of the incoming connection requests (Step S204) based on predefined criteria such as security rules, network traffic, and so forth. Such server socket may be a TCP/IP socket dedicated to listening for client requests. The processor 112 may check for client requests received in the server socket on a periodic basis.

When a connection request associated with a first process sent from the client terminal 120 is accepted by the server socket, the processor 112 would fork a first child process to handle tasks of the first process received from the client terminal 120 (Step S206). Note that the first process may correspond to a first application that has been activated on the client terminal 120, and the client terminal 120 may send the tasks of the first process to the computer system 110 through a first client socket that has been created upon the activation of the first application. On the other hand, the computer system 110 may create a first child socket for the first child process forked from a parent process to specifically receive and handle the tasks of the first process sent from the first client socket of the client terminal 120.

The tasks may be OpenGL commands issued by the first application on the client terminal 120 and scheduled to be performed by the graphic processor 114. For example, when a first graphic task of the first process is received from the client terminal 120 by the first child process, the processor 112 would control the graphic processor 114 to perform the first graphic task by the first child process (Step S208) and return a result of the first graphic task to the client terminal 120 for display (Step S210). In such instance, the user of the client terminal 120 may be given an illusion of a direct control and interaction with the graphic processor 114. Once the first process is inactivated by the client terminal 120, the processor 112 would then close the first child socket and terminate the first child process.

The proposed method would be significantly promising when two or more applications are concurrently running on the client terminal 120, where each running application is made up of one process. For example, a GPS application and a web browser may be concurrently displayed on a split-screen of the client terminal 120 in an autonomous vehicle system. As another exemplary embodiment, while the flow associated with the first process as illustrated in FIG. 2 is in progress, when another connection request associated with a second process sent from the client terminal 120 is accepted by the server socket, the processor 112 would fork a second child process to handle tasks of the second process received from the client terminal 120 with a similar fashion. The second process may correspond to a second application that has also been activated on the client terminal 120 and may be sent to the computer system 110 through a second client socket that has been created upon the activation of the second application. On the other hand, the computer system 110 may create a second child socket for the second child process to specifically receive and handle the tasks of the second process sent from the second client socket of the client terminal 120. For example, when a second graphic task of the second process is received from the client terminal 120 by the second child process, the processor 112 would control the graphic processor 114 to perform the second graphic task by the second child process. Accordingly, each process would be provided with an exclusive client socket on the client terminal 120 and an exclusive child socket on the computer system 110 for communication, and therefore commands issued by different processes would be effectively isolated from each other.

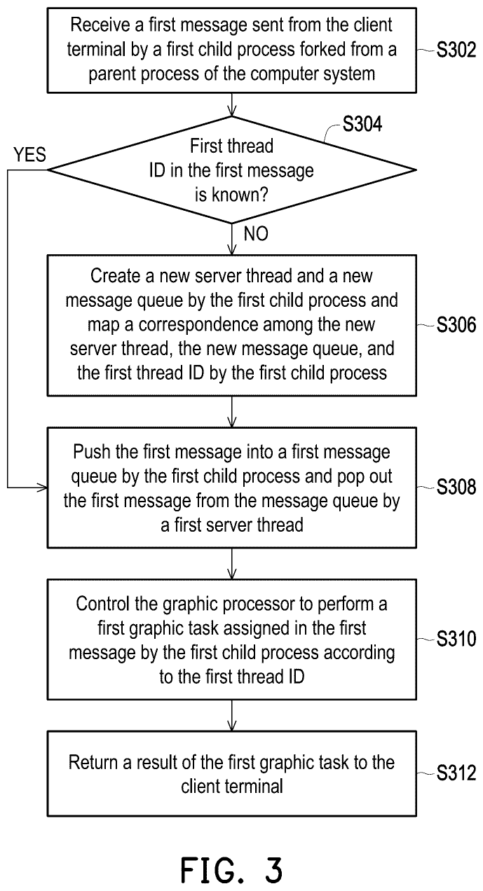

FIG. 3 illustrates a flowchart of a method for handling multi-threads in accordance with an exemplary embodiment of the disclosure, where the steps of FIG. 3 may be implemented by the computer system 110 as illustrated in FIG. 1 as well.

It should be first noted that, prior to the proposed multi-threads scheme, it is assumed that Steps S202-S206 in FIG. 2 have been performed. That is, a child process has been forked from a parent process of the computer system 110, and a child socket has been created to handle tasks of a particular process sent from a client socket of the client terminal 120.

Now, referring FIG. 3 in conjunction with FIG. 1, the processor 112 of the computer system 110 would receive a first message sent from the client terminal 120 by a first child process forked from a parent process of the computer system 110 (Step 302). The first message may include a thread ID inserted by the client terminal 120. In detail, the client terminal 120 may record an OpenGL command with associated parameters assigned to perform a particular graphic task as well as a thread ID corresponding to a thread of the aforesaid OpenGL command in a common message as the first message. The client terminal 120 may serialize the first message by any message serialization technique and send the serialized first message to the computer system 120 via the client socket. The computer system 110 may deserialize the first message to obtain the thread ID.

The processor 112 would determine whether the thread ID (referred to as “a first thread ID” hereafter) included in the first message is known (Step S304). When the first thread ID is unknown, the processor 112 would create a new server thread and a new message queue by the first child process and further map a correspondence among the new server thread, the new message queue, and the first thread ID by the first child process (Step S306).

On the other hand, when the first thread ID is known, that is, when a server thread corresponding to the first thread ID (referred to as “a first server thread”) and a message queue corresponding to the first thread ID (referred to as “a first message queue”) exist, the processor 112 would push the first message into the first message queue by the first child process and pop out the first message from the first message queue by the first server thread to analyze the first message (Step S308). The processor 112 would control the graphic processor 114 to perform a first graphic task assigned in the first message by the first child process according to the first thread ID (Step S310) and return a result of the first graphic task to the client terminal 120 for display (Step S312). In such instance, the user of the client terminal 120 may be given an illusion of a direct control and interaction with the graphic processor 114.

The proposed method would be significantly promising when two or more threads are concurrently issued for execution within an identical process on the client terminal 120. For example, a video screen for video playback and a video menu for user selection of a video player application may be concurrently displayed on the client terminal 120 in an autonomous vehicle system. As another exemplary embodiment, while the flow associated with the first message as illustrated in FIG. 3 is in progress, when the processor 112 receives a second message sent from the client terminal 120 by the first child process, the processor 112 would determine whether a thread ID (referred to as “a second thread ID” hereafter) included in the second message is known so as to determine whether to create a new server thread and a new message queue for the second thread ID before analyzing the second message. After the processor 112 analyzes the second message, the processor 12 would control the graphic processor 114 to perform the second graphic task assigned in the second message by the first child process according to the second thread ID. Accordingly, each thread would be provided with an exclusive thread ID, and therefore commands issued by different threads would be effectively isolated from each other.

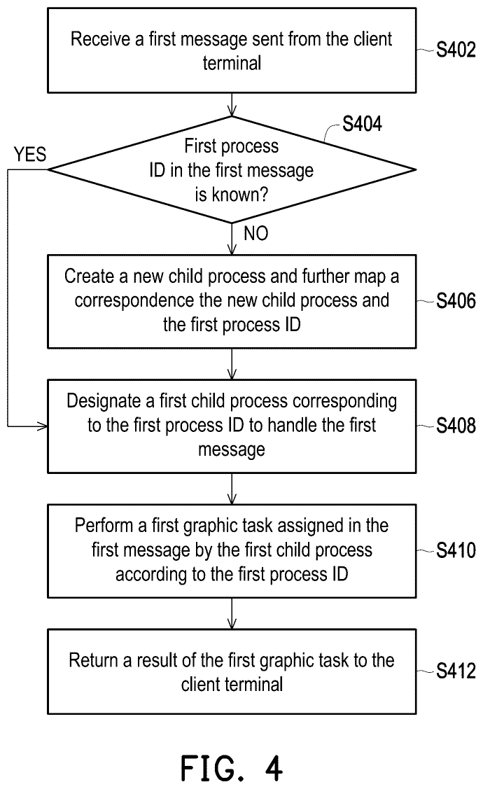

FIG. 4 illustrates a flowchart of a method for handling multi-processes in accordance with another exemplary embodiment of the disclosure, where the steps of FIG. 4 may be implemented by the computer system 110 as illustrated in FIG. 1 as well.

Referring to FIG. 4 in conjunction with FIG. 1, the processor 112 of the computer system 110 would receive a first message sent from the client terminal 120 (Step 402). The first message may include a process ID inserted by the client terminal 120. In detail, the client terminal 120 may record an OpenGL command with associated parameters assigned to perform a particular graphic task as well as a process ID corresponding to a process of the aforesaid OpenGL command in a common message as the first message. The client terminal 120 may serialize the first message by any message serialization technique and send the serialized first message to the computer system 110 via the client socket. The computer system 110 may deserialize the first message to obtain the process ID.

The processor 112 would determine whether the process ID (referred to as “a first process ID” hereafter) included in the first message is known (Step S404). When the first process ID is unknown, the processor 112 would create a new child process and further map a correspondence the new child process and the first process ID (Step S406).

On the other hand, when the first process ID is known, that is, when a child process corresponding to the first process ID exists (referred to as “a first child process”), the processor 112 would designate the first child process to handle the first message (Step S408). The processor 112 would control the graphic processor 114 to perform a first graphic task assigned in the first message by the first child process according to the first process ID (Step S410) and return a result of the first graphic task to the client terminal 120 for display (Step S412). In such instance, the user of the client terminal 120 may be given an illusion of a direct control and interaction with the graphic processor 114.

As another exemplary embodiment, while the flow associated with the first message as illustrated in FIG. 4 is in progress, when the processor 112 receives a second message sent from the client terminal 120, the processor 112 would determine whether a process ID (referred to as “a second process ID” hereafter) included in the second message is known so as to determine whether to create a new child process for the second process ID or to designate an existing child process (referred to as “a second child process” hereafter) corresponding to the second process ID to handle the second message. The processor 112 would control the graphic processor to perform the second graphic task assigned in the second message by the second child process according to the second process ID. That is, each process would be provided with an exclusive process ID, therefore commands issued by different processes would be effectively isolated from each other.

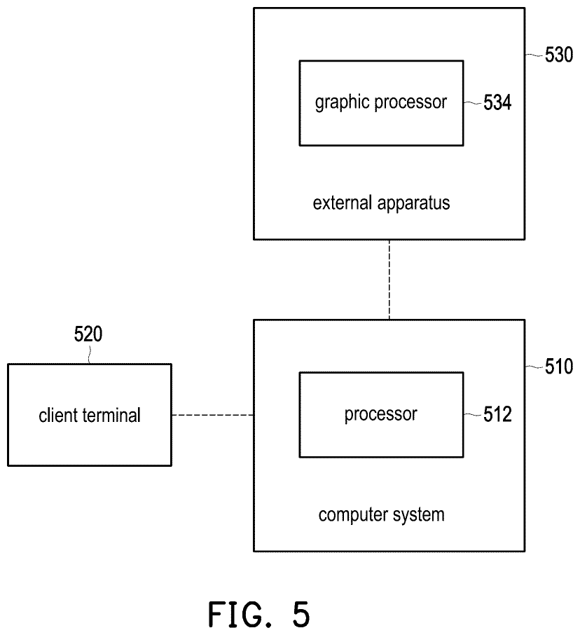

FIG. 5 illustrates a schematic diagram of a computer system in accordance with another exemplary embodiment of the disclosure.

Referring to FIG. 5, a computer system 510 would at least include a processor 512 that is able to establish a connection through a wired or wireless communication scheme with a graphic processor 534 in an external apparatus 530. The computer system 510 may be a computer or an electronic device designed for handling commands sent from a client terminal 520 and controlling the graphic processor 534 in the external apparatus 530 to perform rendering images, videos, and graphic-intensive tasks. The hardware specification of the processor 512 and the graphic processor 534 would be respectively the same as or similar to the processor 112 and the graphic processor 114 as described in FIG. 1. The client terminal 520 may be a computer or an electronic device that utilizes the GPU resource from the external apparatus 530, and therefore the computer system 510 may also be considered as an intermediate handler to all incoming communications between both the external graphic processor 534 and the client terminal 520.

In one exemplary embodiment, the methods for handling multi-processes as illustrated in FIG. 2 and FIG. 4 as well as the method for handling multi-threads as illustrated in FIG. 3 may also be implemented by FIG. 5 except that additional external transmission between the processor 512 and the graphic processor 534 would be involved for the computer system 510 and the external apparatus 530. The descriptions of the flow could be deduced by a skilled person in the art and would be omitted for brevity.

In view of the aforementioned descriptions, effective approaches to handle multi-processes and multi-threads are proposed so as to allow devices with limited or minimum graphic resources to perform intense workload of graphic rendering operations.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A computer system for handling multi-processes comprising:
a graphic processor; and
a processor, configured to:
create a server socket to listen for incoming connection requests;
in response to a connection request associated with a first process sent from a client terminal being accepted by the server socket, fork a first child process to handle tasks of the first process received from the client terminal; and
in response to a first graphic task of the first process being received from the client terminal by the first child process, control the graphic processor to perform the first graphic task by the first child process.

2. The computer system according to claim 1, wherein the processor is configured to:
create a first child socket for the first child process to receive and handle the tasks of the first process sent from a first client socket of the client terminal.

3. The computer system according to claim 2, wherein the first client socket is created in response to the first process being activated by the client terminal.

4. The computer system according to claim 1, wherein the first graphic task of the first process being received from the client terminal is a command corresponding to a graphic library of the graphic processor.

5. The computer system according to claim 1, wherein the processor is further configured to:
in response to another connection request associated with a second process sent from the client terminal being accepted by the server socket, fork a second child process to handle tasks of the second process received from the client terminal; and
in response to a second graphic task of the second process being received from the client terminal by the second child process, control the graphic processor to perform the second graphic task by the second child process.

6. The computer system according to claim 5, wherein the processor is configured to:
create a first child socket for the first child process to receive and handle the tasks of the first process sent from a first client socket of the client terminal; and
create a second child socket for the second child process to receive and handle the tasks of the second process sent from a second client socket of the client terminal, wherein the second child socket is different from the first child socket, and wherein the second client socket is different from the first client socket.

7. The computer system according to claim 1, wherein the processor is further configured to:
in response to the first process being inactivated by the client terminal, close the first child socket and terminate the first child process.

8. A computer system for handling multi-processes comprising:
a processor, configured to:
create a server socket to listen for incoming connection requests;
in response to a connection request associated with a first process sent from a client terminal being accepted by the server socket, fork a first child process to handle tasks of the first process received from the client terminal; and
in response to a first graphic task of the first process being received from the client terminal, control an external graphic processor to perform the first graphic task by the first child process.

9. A method for handling multi-processes, applicable to a computer system having a processor and a graphic processor and performed by the processor, comprising:
creating a server socket to listen for incoming connection requests;
in response to a connection request associated with a first process sent from a client terminal being accepted by the server socket, forking a first child process to handle tasks of the first process received from the client terminal; and
in response to a first graphic task of the first process being received from the client terminal, controlling the graphic processor to perform the first graphic task by the first child process.

10. A method for handling multi-processes, applicable to a computer system having a processor and performed by the processor, comprising:
creating a server socket to listen for incoming connection requests;
in response to a connection request associated with a first process sent from a client terminal being accepted by the server socket, forking a first child process to handle tasks of the first process received from the client terminal; and
in response to a first graphic task of the first process being received from the client terminal, controlling an external graphic processor to perform the first graphic task by the first child process.

11. A computer system for handling multi-threads comprising:
a graphic processor; and
a processor, configured to:
receive a first message sent from a client terminal by a first child process forked from a parent process of the computer system;
determine whether a first thread identification (ID) included in the first message is known; and
in response to the first thread ID being known, control the graphic processor to perform a first graphic task assigned in the first message by the first child process according to the first thread ID.

12. The computer system according to claim 11, wherein the processor is configured to:
push the first message into a first message queue corresponding to the first thread ID by the first child process; and
pop out the first message from the message queue by a first server thread corresponding to the first thread ID to analyze the first message by the first child process.

13. The computer system according to claim 11 further comprising:
in response to the first thread ID being unknown, create a new server thread and a new message queue by the first child process, and map a correspondence among the new server thread, the new message queue, and the first thread ID by the first child process.

14. The computer system according to claim 11, wherein the first thread ID is inserted in the first message in which the first graphic task is assigned by the client terminal.

15. The computer system according to claim 11, wherein the first graphic task of the first process being received from the client terminal is a command corresponding to a graphic library of the graphic processor.

16. The computer system according to claim 11, wherein the processor is further configured to:
receive a second message sent from the client terminal by the first child process of the computer system;
determine whether a second thread ID included in the second message is known; and
in response to the second thread ID being known, control the graphic processor to perform the second graphic task assigned in the second message by the first child process according to the second thread ID.

17. A computer system for handling multi-threads comprising:
a processor, configured to:
receive a first message sent from a client terminal by a first child process forked from a parent process of the computer system;
determine whether a first thread identification (ID) included in the first message is known; and
in response to the first thread ID being known, control an external graphic processor to perform a first graphic task assigned in the first message by the first child process according to the first thread ID.

18. A method for handling multi-threads, applicable to a computer system having a processor and a graphic processor and performed by the processor, comprising:
receiving a first message sent from a client terminal by a first child process forked from a parent process of the computer system;
determining whether a first thread identification (ID) included in the first message is known; and
in response to the first thread ID being known, controlling the graphic processor to perform a first graphic task assigned in the first message by the first child process according to the first thread ID.

19. A method for handling multi-threads, applicable to a computer system having a processor and performed by the processor, comprising:
receiving a first message sent from a client terminal by a first child process forked from a parent process of the computer system;
determining whether a first thread identification (ID) included in the first message is known; and
in response to the first thread ID being known, controlling an external graphic processor to perform a first graphic task assigned in the first message by the first child process according to the first thread ID.

20. A computer system for handling multi-processes comprising:
a graphic processor; and
a processor, configured to:
receive a first message sent from a client terminal;
determine whether a first process identification (ID) included in the first message is known; and
in response to the first process ID being known, control the graphic processor to perform a first graphic task of a first process assigned in the first message according to the first process ID.

21. The computer system according to claim 20, wherein the processor is configured to:
in response to the first process ID being known, designate an existing child process corresponding to the first process ID to handle the first message.

22. The computer system according to claim 20 further comprising:
in response to the first process ID being unknown, create a new child process and further map a correspondence the new child process and the first process ID.

23. The computer system according to claim 20, wherein the first process ID is inserted in the first message in which the first graphic task is assigned by the client terminal.

24. The computer system according to claim 20, wherein the first graphic task of the first process being received from the client terminal is a command corresponding to a graphic library of the graphic processor.

25. The computer system according to claim 20, wherein the processor is further configured to:
receive a second message sent from the client terminal;
determine whether a second process identification (ID) included in the second message is known; and
in response to the second process ID being known, control the graphic processor to perform a second graphic task of a second process assigned in the second message according to the second process ID.

26. A computer system for handling multi-processes comprising:
a processor, configured to:
receive a first message sent from a client terminal;
determine whether a first process identification (ID) included in the first message is known; and
in response to the first process ID being known, control an external graphic processor to perform a first graphic task of a first process assigned in the first message according to the first process ID.

27. A method for handling multi-processes, applicable to a computer system having a processor and a graphic processor and performed by the processor, comprising:
receiving a first message sent from a client terminal;
determining whether a first process identification (ID) included in the first message is known; and
in response to the first process ID being known, controlling the graphic processor to perform a first graphic task of a first process assigned in the first message according to the first process ID.

28. A method for handling multi-processes, applicable to a computer system having a processor and performed by the processor, comprising:
receiving a first message sent from a client terminal;
determining whether a first process identification (ID) included in the first message is known; and
in response to the first process ID being known, controlling an external graphic processor to perform a first graphic task of a first process assigned in the first message according to the first process ID.
